(19) United States
(12) Patent Application Publication
(10) Pub. No.: US 2006/0212612 A1
(43) Pub. Date: Sep. 21, 2006

(54) I/O controller, signal processing system, and method of transferring data

(75) Inventors: Takeshi Takamiya, Hamura-shi (JP); Yoshiaki Murano, Fuchu-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/356,214

(22) Filed: Feb. 17, 2006

(30) Foreign Application Priority Data
Mar. 15, 2005 (JP) 2005-073740

(51) Int. Cl. G06F 13/28

(52) U.S. Cl. 710/24

(57) ABSTRACT

According to one embodiment, an I/O controller transfers data between a memory and an I/O device by request of a processor. The I/O controller includes a storage unit to which write access is gained by the processor and which stores descriptor chain information written by the processor, the descriptor chain information including a plurality of descriptors each describing a content of data transfer to be executed, and a data transfer control unit which processes the descriptors in sequence and executes a series of data transfers by direct memory access to transfer data from the memory to the I/O device.

### CROSS-REFERENCE TO RELATED APPLICATIONS

This application is based upon and claims the benefit of priority from prior Japanese Patent Application No. 2005-073740, filed Mar. 15, 2005, the entire contents of which are incorporated herein by reference.

### BACKGROUND

1. Field

One embodiment of the invention relates to an I/O controller for transferring data to an I/O device from a memory, a signal processing system, and a method of transferring data.

2. Description of the Related Art

Various types of signal processing systems such as a personal computer and an audio video (AV) apparatus have recently been developed. In these signal processing systems, a direct memory access (DMA) transfer is used in order to transfer a large number of data streams such as AV data with efficiency.

A DMA transfer using descriptor chain information, i.e., descriptor based DMA has started to be used. The descriptor chain information is composed of a plurality of chained transfer descriptors (or simply referred to as descriptors). Each of the transfer descriptors is transfer information that describes the contents of data transfer to be executed. The descriptor chain information is prepared on a main memory by software before a DMA transfer starts.

A DMA controller reads the current transfer descriptor from the main memory and executes a DMA transfer in accordance with the read transfer descriptor. When the DMA transfer is completed, the DMA controller reads the next transfer descriptor from the main memory. Thus, the DMA controller automatically executes a series of data transfers the number of which corresponds to the number of transfer descriptors included in the descriptor chain information.

However, the DMA controller has to read a transfer descriptor from the main memory each time it executes a DMA transfer. This read operation increases overheads about the processing of the descriptor chain information and the usage rate of a memory bus.

Jpn. Pat. Appln. KOKAI Publication 6-236341 discloses an I/O controller that executes a DMA transfer. The I/O controller reads two channel control blocks (CCB) each including transfer information from a main memory and sets them in a register of the I/O controller.

Even in the I/O controller of the above Publication, however, read access has to be gained to the main memory in order to obtain the transfer information. Overheads about the processing of the transfer information cannot be decreased, nor can be the usage rate of a memory bus.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram showing a configuration of a signal processing system according to an embodiment of the invention;

FIG. 2 is an exemplary diagram showing a configuration of a descriptor chain used in the signal processing system shown in FIG. 1;

FIG. 3 is an exemplary block diagram showing a configuration of the signal processing system shown in FIG. 1, which is applied to a digital TV broadcasting receiver;

FIG. 4 is an exemplary block diagram showing a configuration of an I/O controller used in the signal processing system shown in FIG. 3;

FIG. 5 is an exemplary diagram showing a relationship between a TD chain and a video memory in the signal processing system shown in FIG. 3;

FIG. 6 is an exemplary flowchart showing a procedure for a DMA transfer in the signal processing system shown in FIG. 3;

FIG. 7 is an exemplary diagram showing another relationship between the TD chain and the video memory in the signal processing system shown in FIG. 3;

FIG. 8 is an illustration of two video signals output from a display controller provided in the signal processing system shown in FIG. 3; and

FIG. 9 is an exemplary block diagram showing a configuration of a DMAC used in the signal processing system shown in FIG. 3.

### DETAILED DESCRIPTION

Various embodiments according to the invention will be described hereinafter with reference to the accompanying drawings. In general, according to one embodiment of the invention, an I/O controller that transfers data between a memory and an I/O device by request of a processor, includes a storage unit to which write access is gained by the processor and which stores descriptor chain information written by the processor, the descriptor chain information including a plurality of descriptors each describing a content of data transfer to be executed, and a data transfer control unit which processes the descriptors in sequence and executes a series of data transfers by direct memory access to transfer data from the memory to the I/O device.

FIG. 1 shows a configuration of a signal processing system according to the embodiment of the invention. The signal processing system is a system that processes digital signals and is implemented as a personal computer, a TV set, an audio video (AV) apparatus and the like.

The signal processing system includes a central processing unit (CPU) 11, a main memory 12, an I/O controller 13 and an I/O device 14. These components are connected to a processor bus 10.

The CPU 11 is a processor that processes various items of data to control an operation of the signal processing system. The main memory 12 is a memory device that stores programs to be executed by the CPU 11 and data to be processed by the CPU 11. The I/O controller 13 controls the I/O device 14. By request of the CPU 11, the I/O controller 13 transfers data between the main memory 12 and I/O device 14 by direct memory access (DMA). To execute the DMA, the I/O controller 13 includes a DMA controller (DMAC) 101.

The DMAC 101 is a data transfer control unit for executing a so-called descriptor based DMA transfer. The DMAC 101 executes a DMA transfer in accordance with a transfer descriptor TD (simply referred to as descriptor TD). In other words, the DMAC 101 executes a DMA transfer in accordance with descriptor chain information (TD chain). The descriptor chain information is information about the contents of a plurality of data transfers to be executed and includes a plurality of transfer descriptors TDs that describe the contents of the data transfers. These transfer descriptors TDs are chained.

The DMAC 101 includes a TD chain storage unit 102 for storing the TD chain. The TD chain storage unit 102 is a local storage unit provided in the DMAC 101. The CPU 11 can gain write access to the TD chain storage unit 102. The TD chain storage unit 102 stores a TD chain that is written by the CPU 11. The TD chain storage unit 102 is a register or a local memory.

The DMAC 101 sequentially processes the transfer descriptors TDs included in the TD chain written to the TD chain storage unit 102 by the CPU 11, thereby executing a series of data transfers between the main memory 12 and the I/O device 14 by direct memory access.

In the signal processing system of the present embodiment, the TD chain is held in the DMAC 101 of the I/O controller 13. Thus, the I/O controller 13 need not perform a memory read operation to read the current transfer descriptor TD out of the main memory 12 each time it executes a DMA transfer. It is therefore possible to greatly decrease overheads about the processing of the TD chain. Access to the memory for reading a transfer descriptor TD is gained locally in the DMAC 101 and no access to the bus 10 is done. The band of the bus 10 can thus be secured.

Data transfer between the main memory 12 and the I/O device 14 will be described.

(1) The CPU 11 writes a TD chain to the TD chain storage unit 102 in the DMAC 101 before a DMA transfer is started. Then, the CPU 11 issues a command to a control register in the DMAC 101 to instruct the DMAC 101 to start to execute a data transfer.

(2), (3) Referring to a transfer descriptor included in the TD chain stored in the TD chain storage unit 102, the DMAC 101 determines the source of the data transfer and the destination thereof. Then, the DMAC 101 starts to execute a DMA transfer. If the source is the main memory 12 and the destination is the I/O device 14, the DMAC 101 reads data out of the main memory 12 and writes it to the I/O device 14. If the source is the I/O device 14 and the destination is the main memory 12, the DMAC 101 reads data out of the I/O device 14 and writes it to the main memory 12.

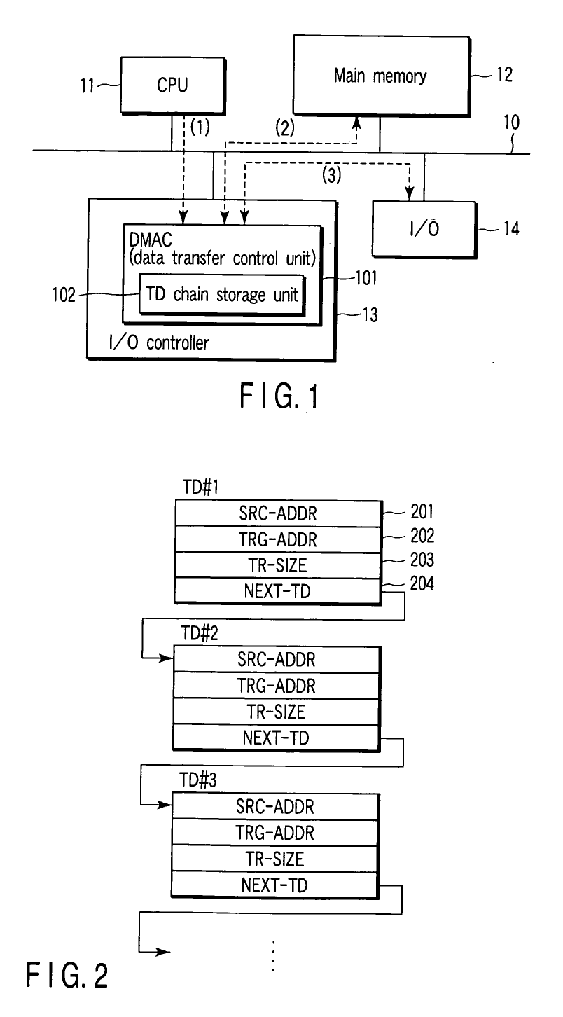

FIG. 2 shows a configuration of a TD chain stored in the TD chain storage unit 102.

Each of transfer descriptors (TD#1, TD#2, TD#3, . . . ) included in the TD chain is transfer information that describes the contents of data transfer to be executed. Each transfer descriptor (TD) includes a source address (SRC_ADDR) field 201, a destination address (TRG_ADDR) field 202, a transfer size (TR_SIXE) field 203 and a pointer (NEXT_TD) field 204.

The source address (SRC_ADDR) field 201 represents an address that stores data to be transferred. The destination address (TRG_ADDR) field 202 represents an address of a destination to which data is transferred. The transfer size (TR_SIXE) field 203 represents the size of data to be transferred.

The pointer (NEXT_TD) field 204 represents a location in which the next TD is stored. For example, the pointer (NEXT_TD) field 204 of TD#1 represents the initial address of TD#2, and the pointer (NEXT_TD) field 204 of TD#2 represents the initial address of TD#3.

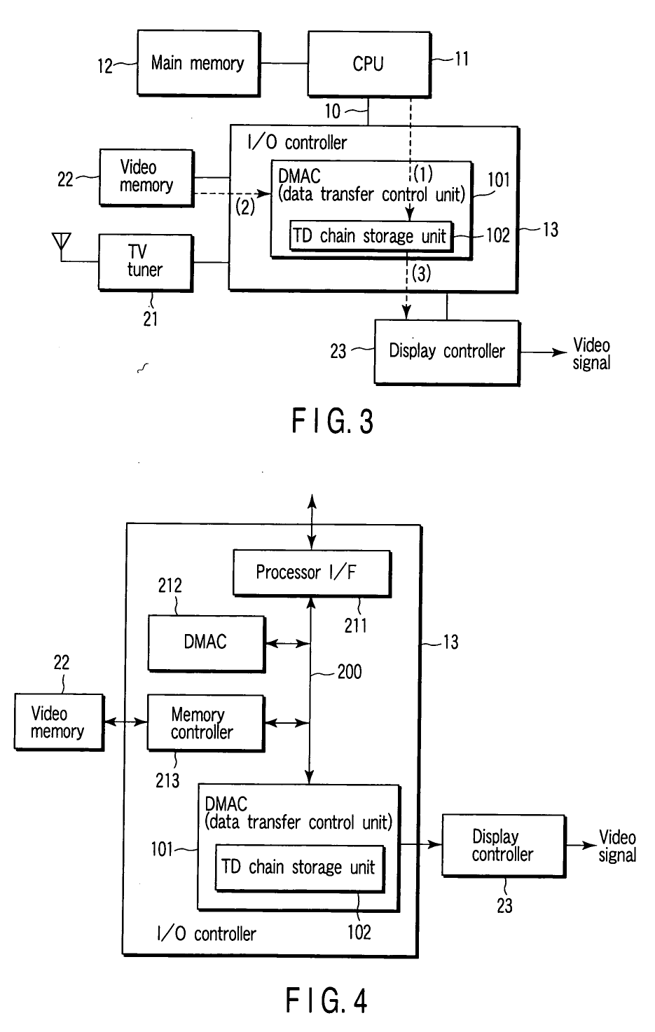

FIG. 3 shows a configuration of the signal processing system that is applied to a digital TV broadcasting receiver.

Referring to FIG. 3, the CPU 11 is implemented as a processor that includes a memory controller for controlling the main memory 12. The I/O controller 13 is connected to the CPU 11 via the processor bus 10. The I/O controller 13 controls a TV tuner 21, a video memory 22 and a display controller 23.

The TV tuner 21 is a receiving apparatus for receiving digital broadcast program data. The digital broadcast program data is composed of a transport stream including video data that is compression-encoded by MPEG2 or the like. The transport stream received by the TV tuner 21 is transmitted to the CPU 11 via the I/O controller 13. The CPU 11 decodes the compression-encoded video data included in the transport stream. This decoding process is performed on the main memory 12. The decoded video data is transferred from the main memory 12 to the video memory 22. The video memory 22 is a local memory connected to the I/O controller 13 and used as a buffer that stores video data to be displayed. The video memory 22 stores, for example, video data for eight frames. The video memory 22 is mapped in memory address space to which the CPU 11 can gain access.

The DMAC 101 sequentially processes a plurality of transfer descriptors TDs included in a TD chain that is written to the TD chain storage unit 102 by the CPU 11. Thus, the DMAC 101 executes a series of data transfers for transferring video data from the video memory 22 to the display controller 23 by direct memory access. The display controller 23 is an I/O device that outputs the video data, which is transferred from the video memory 22, to a display device. The display controller 23 generates a video output signal corresponding to the video data transferred from the video memory 22 and outputs the video output signal to a display device such as a TV monitor.

Since the transfer of video data from the video memory 22 to the display controller 23 is part of a screen refresh operation, software for controlling the reproduction of the video data need not manage success or failure of the transfer. In other words, the software has only to manage the video data until the video data is transferred to the video memory 22. Consequently, the DMAC 101 need not notify the CPU 11 of the completion of the transfer each time it completes processing one transfer descriptor TD.

In a normal system wherein a DMAC reads a transfer descriptor TD out of a main memory, the DMAC writes a status flag indicating the completion of a transfer to a transfer descriptor TD on the main memory and notifies a CPU of the completion of processing of the transfer descriptor TD.

The system shown in FIG. 3 need not notify the CPU 11 of the completion of processing of a transfer descriptor TD. No transfer descriptors TD are required on the main memory 12. Consequently, the system shown in FIG. 3 is favorable for the configuration of the I/O controller 13 whose DMAC 101 holds a TD chain therein.

FIG. 4 shows a configuration of the I/O controller 13 that is applied to the signal processing system shown in FIG. 3.

The I/O controller 13 includes an internal bus 200, a processor interface 211, a DMAC 212 and a memory controller 213 as well as the DMAC 101. The processor interface 211 communicates with the CPU 11 via the processor bus 10. The DMAC 212 executes a DMA transfer to transfer video data from the main memory 11 to the video memory 22. Like the DMAC 101, the DMAC 212 sequentially processes a plurality of transfer descriptors included in a TD chain that is written to a TD chain storage unit in the DMAC 212 by the CPU 11. Thus, the DMAC 212 executes a series of data transfers to transfer video data from the main memory 11 to the video memory 22. The transfer of data from the main memory 12 to the video memory 22 by the DMAC 212 and the transfer of data from the video memory 22 to the display controller 23 by the DMAC 101 are synchronized with each other. The CPU 11 can write video data to the video memory 22 without using the DMAC 212. The memory controller 213 controls the video memory 22.

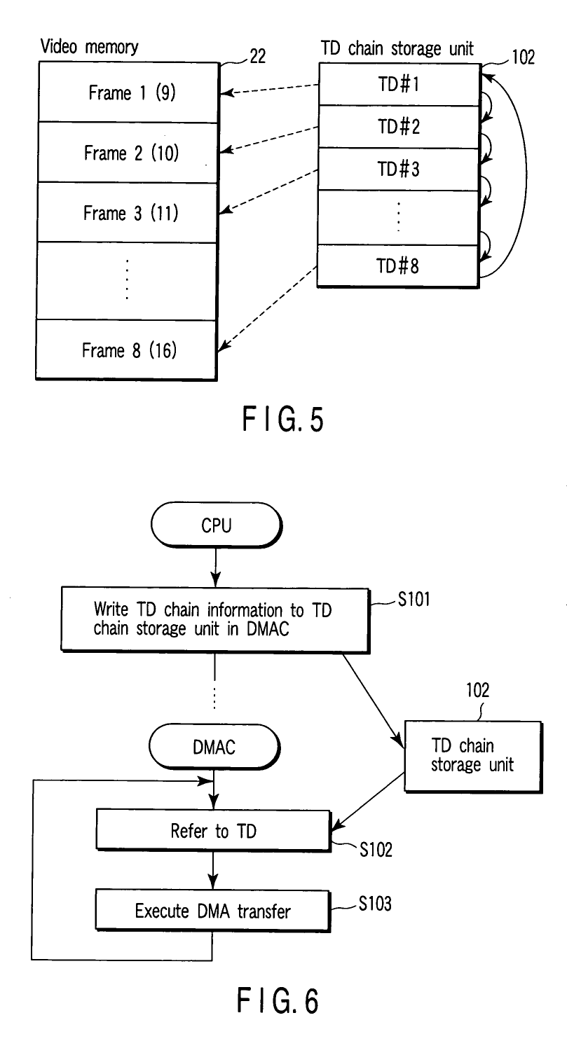

FIG. 5 shows a relationship between the TD chain stored in the TD chain storage unit 102 and the video memory 22.

The video memory 22 includes eight storage areas that store eight frame data items, respectively. The TD chain is composed of eight transfer descriptors (TD#1 to TD#8) that indicate the eight storage areas as the sources of data transfer. The pointer in TD#8 represents TD#1 as a transfer descriptor to be processed next. Thus, the DMAC 101 repeatedly processes the TD chain including the eight transfer descriptors (TD#1 to TD#8). The transfer size of each of the transfer descriptors coincides with the data size of one frame. The contents of video data stored in the video memory 22 are updated in sequence with given timing. In the first-round TD chain process, data of each of frames 1 to 8 is transferred. In the second-round TD chain process, data of each of frames 9 to 16 is transferred. In the third-round TD chain process, data of each of frames 17 to 24 is transferred.

If the number of storage areas is N, the number of transfer descriptors TD included in the TD chain is also N. N is an integer that is larger than one.

A procedure for transferring data from the video memory 22 to the display controller 23 will be described with reference to the flowchart shown in FIG. 6.

The CPU 11 writes a TD chain to the TD chain storage unit 102 in the DMAC 101 (step S101).

The DMAC 101 refers to the initial transfer descriptor in the TD chain stored in the TD chain storage unit 102 (step S102) and executes a DMA transfer designated by the transfer descriptor (step S103). Completing the DMA transfer, the DMAC 101 refers to the next descriptor in the TD chain stored in the TD chain storage unit 102 (step S102) and executes a DMA transfer designated by the transfer descriptor (step S103). Thus, the DMAC 101 sequentially processes the transfer descriptors in the TD chain stored in the TD chain storage unit 102.

There now follows a description of a process of transferring two different video data items from the video memory 22 to the display controller 23 at the same time. This process is used for displaying two video data items on two displays at the same time.

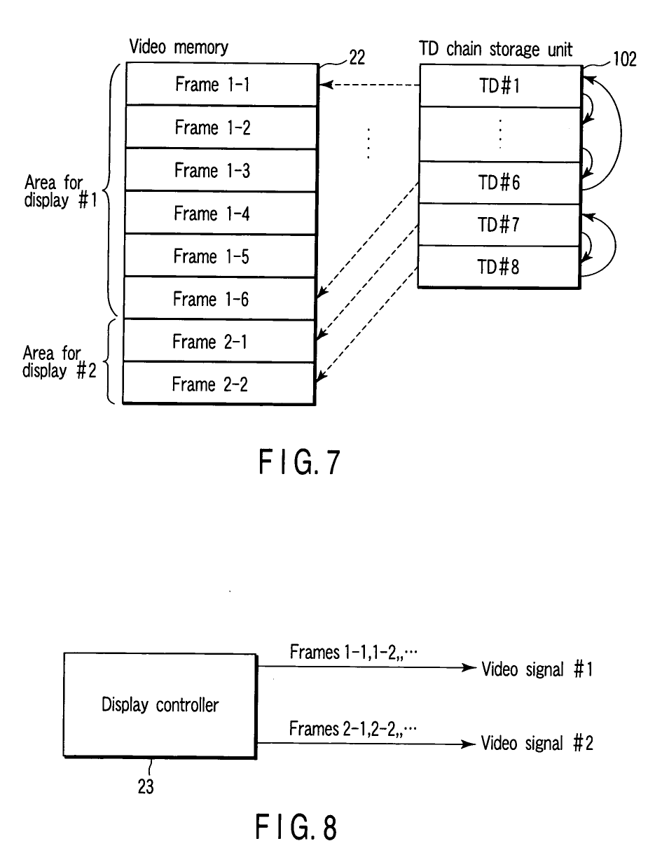

FIG. 7 shows another relationship between the TD chain stored in the TD chain storage unit 102 and the video memory 22. The video memory 22 is divided into two storage areas. One of the storage areas is an area for storing video data for display #1, and the other is an area for storing video data for display #2. The area for storing video data for display #1 includes N (six, for example) first storage areas for storing N (six, for example) frame data items, respectively. The area for storing video data for display #2 includes M (two, for example) second storage areas for storing M (two, for example) frame data items, respectively.

Of the eight transfer descriptors (TD#1 to TD#8) of the TD chain, N or six transfer descriptors (TD#1 to TD#6) designate their respective N or six first storage areas for display #1 as the sources of data transfer, and the remaining M or two transfer descriptors (TD#7 and TD#8) designate their respective M or two second storage areas for display #2 as the sources of data transfer. The pointer in TD#6 represents TD#1 as a transfer descriptor to be processed next, and the pointer in TD#8 represents TD#7 as a transfer descriptor to be processed next. N and M each have only to be an integer that is larger than one.

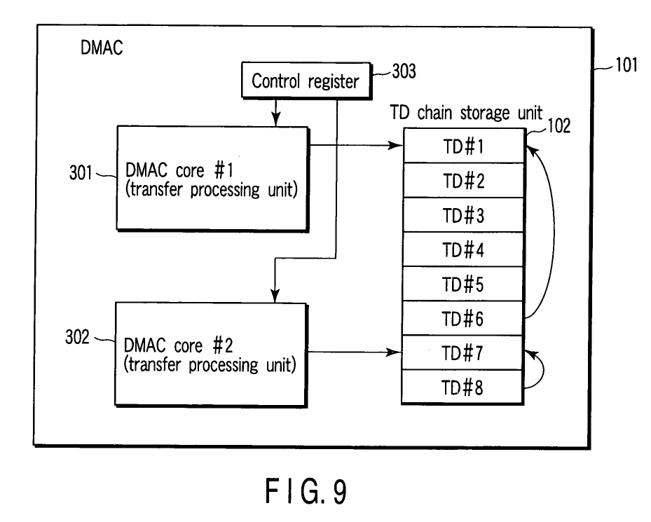

Referring to FIG. 9, the DMAC 101 includes two DMAC cores 301 and 302. The DMAC core 301 serves as a first transfer processing unit and the DMAC core 302 serves as a second transfer processing unit. The DMAC core 301 processes six transfer descriptors (TD#1 to TD#6) and the DMAC core 302 processes two transfer descriptors (TD#7 and TD#8). Thus, two video data items can be transferred from the video memory 22 to the display controller 23 in synchronization with each other. The display controller 23 generates two video output signals as shown in FIG. 8. One of the video output signals is generated from data to be transferred from six storage areas for display #1, and the other video output signal is generated from data to be transferred from two storage areas for display #2.

The configuration of the DMAC 101 will be described in detail with reference to FIG. 9.

The DMAC 101 includes a TD chain storage unit 102, two DMAC cores 301 and 302 and a control register 303. The control register 303 holds first pointer information indicating the location of the initial TD (TD#1) to be processed by the DMAC core 301 and second pointer information indicating the location of the initial TD (TD#7) to be processed by the DMAC core 302. The CPU 11 writes the first pointer information and the second pointer information to the control register 303. The DMAC core 301 repeats the process of TD#1 to TD#6 to execute a DMA transfer to transfer video data for display #1 to the display controller 23. The DMAC core 302 repeats the process of TD#7 and TD#8 to perform a DMA transfer for transferring video data for display #2 to the display controller 23.

In the present embodiment, the TD chain storage unit 102 is provided in the DMAC 101 as described above. The overheads about the processing of the TD chain can be decreased and so can be the usage rate of the bus. It is thus possible to increase data transfer efficiency. Moreover, the band of a bus such as a processor bus, a memory bus and a system bus can be secured and accordingly the system can be increased in performance.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An I/O controller that transfers data between a memory and an I/O device by request of a processor, comprising:
a storage unit to which write access is gained by the processor and which stores descriptor chain information written by the processor, the descriptor chain information including a plurality of descriptors each describing a content of data transfer to be executed; and
a data transfer control unit which processes the descriptors in sequence and executes a series of data transfers by direct memory access to transfer data from the memory to the I/O device.

2. The I/O controller according to claim 1, wherein the memory includes N (N>1) storage areas which store N frame data items that form video data, the descriptor chain information includes N descriptors that designate the N storage areas as sources of data transfer, and the data transfer control unit repeatedly processes the descriptor chain information to transfer the video data from the memory to the I/O device.

3. The I/O controller according to claim 2, wherein the I/O device is configured to output the video data, which is transferred from the memory, to a display device.

4. The I/O controller according to claim 1, wherein the memory includes N (N>1) first storage areas which store N of frame data items that form first video data and M (M>1) second storage areas which store M frame data items that form second video data,
the descriptor chain information includes first descriptor chain information having N first descriptors that designate the N first storage areas as sources of data transfer and second descriptor chain information having M second descriptors that designate the M second storage areas as sources of data transfer, and
the data transfer control unit includes a first transfer processing unit which repeatedly processes the first descriptor chain information to transfer the first video data from the memory to the I/O device by direct memory access and a second transfer processing unit which repeatedly processes the second descriptor chain information to transfer the second video data from the memory to the I/O device by direct memory access.

5. The I/O controller according to claim 4, wherein the I/O device is configured to output the first video data, which is transferred from the memory, to a first display device and output the second video data, which is transferred from the memory, to a second display device.

6. The I/O controller according to claim 1, wherein the memory is a video memory which stores video data, the I/O controller further comprises means for executing a series of data transfers by direct memory access to transfer video data from a main memory to the video memory, and the data transfer control unit processes the descriptors in sequence and executes a series of data transfers by direct memory access to transfer the video data from the video memory to the I/O device.

7. A signal processing system comprising:
a processor which processes various data items;
an I/O device;
a memory; and
an I/O controller coupled to the processor to transfer data from the memory to the I/O device by request of the processor, the I/O controller comprising a storage unit to which write access is gained by the processor and which stores descriptor chain information written by the processor, the descriptor chain information including a plurality of descriptors each describing a content of data transfer to be executed, and a data transfer control unit which processes the descriptors in sequence and executes a series of data transfers by direct memory access to transfer data from the memory to the I/O device.

8. The signal processing system according to claim 7, wherein the memory includes N (N>1) storage areas which store N frame data items that form video data, the descriptor chain information includes N descriptors that designate the N storage areas as sources of data transfer, and the data transfer control unit repeatedly processes the descriptor chain information to transfer the video data from the memory to the I/O device.

9. The signal processing system according to claim 8, wherein the I/O device is configured to output the video data, which is transferred from the memory, to a display device.

10. The signal processing system according to claim 7, wherein the memory includes N (N>1) first storage areas which store N frame data items that form first video data and M (M>1) second storage areas which store M frame data items that form second video data,
the descriptor chain information includes first descriptor chain information having N first descriptors that designate the N first storage areas as sources of data transfer and second descriptor chain information having M second descriptors that designate the M second storage areas as sources of data transfer, and
the data transfer control unit includes a first transfer processing unit which repeatedly processes the first descriptor chain information to transfer the first video data from the memory to the I/O device by direct memory access and a second transfer processing unit which repeatedly processes the second descriptor chain information to transfer the second video data from the memory to the I/O device by direct memory access.

11. The signal processing system according to claim 7, wherein the memory is a video memory which stores video data, the I/O controller includes means for executing a series of data transfers to transfer video data from a main memory to the video memory by direct memory access, and the data transfer control unit processes the descriptors in sequence and executes a series of data transfers by direct memory access to transfer the video data from the video memory to the I/O device.

12. A method of transferring data from a memory to an I/O device by direct memory access by request of a processor, the method comprising:
writing descriptor chain information including a plurality of descriptors each describing a content of data transfer to be executed to a local storage unit in a controller which is configured to gain the direct memory access; and
processing the descriptors in sequence by the controller and executing a series of data transfers by direct memory access to transfer data from the memory to the I/O device.

13. The method according to claim 12, wherein the memory includes N (N>1) storage areas which store N frame data items that form video data, and the descriptor chain information includes N descriptors that designate the N storage areas as sources of data transfer.

14. The method according to claim 12, wherein the memory is a video memory which stores video data, the method further comprises executing a series of data transfers by direct memory access to transfer video data from a main memory to the video memory, and the executing a series of data transfers includes processing the descriptors in sequence and executing a series of data transfers by direct memory access to transfer the video data from the video memory to the I/O device.
